(19) United States
(12) Patent Application Publication
(10) Pub. No.: US 2015/0003109 A1
(43) Pub. Date: Jan. 1, 2015

(54) DIRECT EDGE-LIT BACKLIGHTING MODULE

(71) Applicant: UNITY OPTO TECHNOLOGY CO., LTD., New Taipei City (TW)

(72) Inventors: Ching-Huei Wu, New Taipei City (TW); Ko-Wei Lu, New Taipei City (TW); Wei-Chung Lin, New Taipei City (TW); Pei-Heng Wu, New Taipei City (TW)

(73) Assignee: UNITY OPTO TECHNOLOGY CO., LTD., New Taipei City (TW)

(21) Appl. No.: 14/023,665

(22) Filed: Sep. 11, 2013

(30) Foreign Application Priority Data
Jun. 28, 2013 (TW) 102212186

(51) Int. Cl. F21V 8/00

(52) U.S. Cl. CPC G02B 6/0035; G02B 6/0073
USPC 362/612

(57) ABSTRACT

A direct edge-lit backlighting module includes a plurality of first LEDs separated by a first interval from one anther on a substrate and emitting a light in a direction parallel to the substrate and corresponding to each first interval, and a plurality of second LEDs arranged in another direction opposite to the aforementioned direction and alternately arranged with the first LEDs and emit a light source, so as to form at least one light bar on the substrate. A light guide plate covers the LEDs for guiding emitted lights to uniformly distribute the intensity of light. The method of arranging the LEDs alternately not only can eliminate dark shadows and reduce the cavity height of the module, but also can decrease the quantity of LEDs used, which helps conserving energy and achieves environmental protection.

### CROSS-REFERENCE TO RELATED APPLICATIONS

This non-provisional application claims priority under 35 U.S.C. § 119(a) on Patent Application No(s). 102212186 filed in Taiwan, R.O.C. on Jun. 28, 2013, the entire contents of which are hereby incorporated by reference.

### BACKGROUND OF THE INVENTION

1. Field of the Invention

The present invention generally relates to the field of illumination devices, in particular to a thin direct edge-lit backlighting module capable of projecting a light source of a light emitting diode (LED) onto a light exiting surface to uniformly distributing light intensity, and this backlighting module can be used extensively as a display light source for various types of liquid crystal displays (LCDs).

2. Description of the Related Art

Since LCD is a passive display device with a self light emitting function, it is necessary to install a backlighting module to provide a light source required for the display of a display panel, and the brightness of a surface light source produced by the backlighting module determines the display quality of the LCD directly. In addition, LED with the features of high light emitting efficiency, long life and low power consumption has become the best choice for the light source applied to the backlighting module. At present, the backlighting module is mainly divided into two types, respectively: an edge-lit backlighting module and a direct-lit backlighting module according to its structure, wherein the direct-lit backlighting module has the light source arranged precisely below the backlighting module to provide the features of high luminance, good viewing angle and high utilization rate, and thus is suitable for the application in super large displays. On the other hand, the edge-lit backlighting module adopts the design of entering the light source from edges and has the features of light weight, narrow frame, and low power consumption, and thus is applied extensively in small and mid-size LCDs below 18″.

However, the conventional direct-lit backlighting module includes a plurality of LED light source arranged in matrix, or includes a plurality of LED lamps arranged parallelly with each other on a backplane; and a reflector installed on the backplane reflects the light source upward, and a light guide plate diffuses the light sources uniformly to achieve uniform planar lighting at the light exiting surface. Therefore, the direct-lit backlighting module will use more LED light sources or LED lamps and a larger space for accommodating the light sources. As a result, the overall thickness, weight and power consumption of the module will be increased; and thus it is not beneficial for the miniaturization of present existing electronic products, environmental protection and energy saving.

The conventional edge-lit backlighting module has a plurality of LED light sources arranged in matrix and installed on two opposite sides of a backplane respectively, and a light guide plate is covered onto the backplane to guide and change the path of the exit light in order to emit the light of the LED light source uniformly and overcome the issue of high directivity. Although the edge-lit backlighting module can use less LED light sources or LED lamps, yet the light sources are installed on both sides of the backlighting module, and the light guide performance of the light guide plate is limited, so that the middle of the module has an insufficient illumination brightness, and thus is not beneficial to the overall light uniformity on the light exiting surface of the module.

In view of the aforementioned drawbacks, it is a main subject of the present invention to improve the layout of the LED light sources and the structural design of the light guide plate and provide light with excellent planar uniformity, which is unlike the structure of the conventional direct-lit and edge-lit backlighting module. In the meantime, the backlighting module of the present invention has the features of small thickness, high intensity, high environmental friendliness, and applicable for large size display devices, so that the invention can promote the LCD industry and improve the economic value of the products.

### SUMMARY OF THE INVENTION

Therefore, it is a primary objective of the present invention to provide a direct edge-lit backlighting module with the feature of low power consumption, wherein the LEDs are alternately arranged to reduce the quantity of LEDs used and improve the distribution of the light sources to achieve the effects of enhancing the light illumination uniformity and reducing chromatic aberration.

To achieve the foregoing objective, the present invention provides a direct edge-lit backlighting module comprising a substrate, a plurality of first LEDs, a plurality of second LEDs and a light guide plate, wherein the first LEDs and the second LEDs are installed on the substrate, and the light guide plate covers the first LEDs and the second LEDs for guiding lights emitted from the first LEDs and the second LEDs to uniformly distributing light intensity, characterized in that the first LEDs are separated by a first interval X from one another and emit a light in a direction parallel to the substrate, and the first interval X falls within a range of 0<X≦10 cm; the second LEDs emit a light in another direction opposite to the direction and are arranged alternately relative to the first LEDs; and the second LEDs are provided at locations corresponding to the first intervals and are apart from one another, such that at least one light bar is formed on the substrate.

Wherein, the first LEDs and the second LEDs are arranged with a second interval Y apart from each other and parallelly and alternately arranged on both sides of the light bar, wherein Y falls within a range of 0<Y≦5 cm, or the first LEDs and the second LEDs are alternately arranged along a straight line of the light bar.

In addition, the light guide plate has a plurality of slots corresponding to the light bar, and the slots are rectangular spaces for containing the first LEDs and the second LEDs, and the light guide plate has a reflective microstructure or mesh for guiding the light sources emitted from the first LEDs and the second LEDs.

In summation, the present invention adopts a light bar with the design of arranging the LED light sources alternately to reduce the quantity of LEDs significantly and the power consumption effectively. The present invention also uses light guide plate to replace air as the medium for guiding the light path, so as to decrease the cavity height of the module to 2-45 mm, as well as reducing the volume and thickness of the module. In addition, by disposing light sources alternately to diffuse light and setting the light bar at the middle of the light guide plate instead of the edges of the light guide plate, one can improve the light diffusion angle and the overall chromatic aberration to avoid dark shadows appeared on the light exiting surface of the module; and thus, light uniformity is improved. In addition, the light bar is attached onto the substrate directly, so that heat can be dissipated effectively. Therefore, the direct edge-lit backlighting module concurrently has the advantages of both of the direct-lit backlighting module and the edge-lit backlighting module.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a perspective view of a first preferred embodiment of the present invention;

FIG. 2 is a schematic view of disposing an LED of the first preferred embodiment of the present invention;

FIG. 3 is a perspective view of a second preferred embodiment of the present invention;

FIG. 4 is a schematic view of disposing an LED of the second preferred embodiment of the present invention; and

FIG. 5 is a sectional view of a second preferred embodiment of the present invention.

### DETAILED DESCRIPTION OF THE PREFERRED EMBODIMENTS

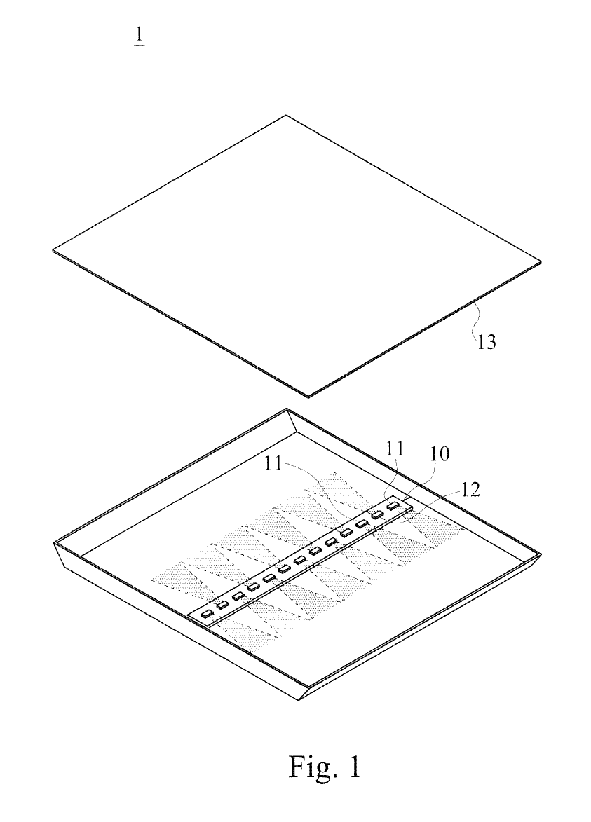

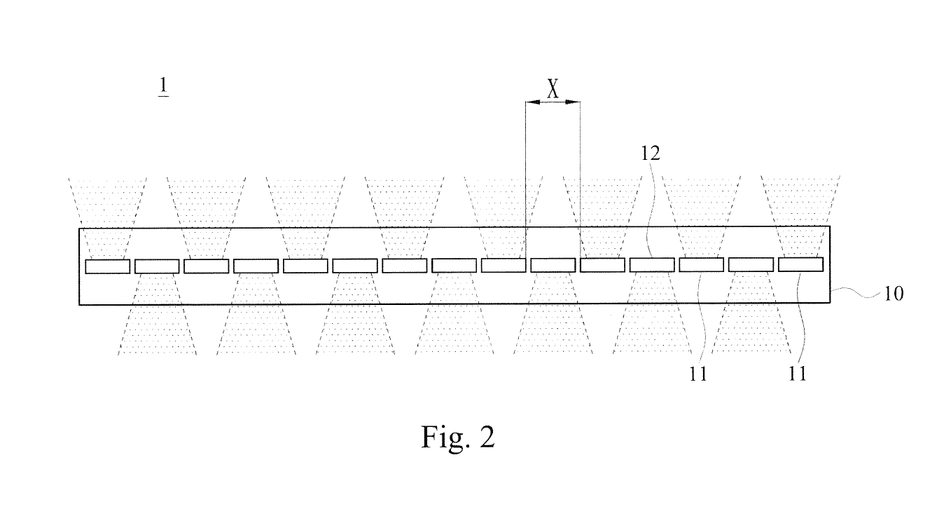

With reference to FIGS. 1 and 2 for a perspective view of a first preferred embodiment of the present invention and a schematic view of disposing an LED of the first preferred embodiment of the present invention respectively. As shown in the figures, the direct edge-lit backlighting module 1 is unlike the conventional direct-lit display light source; it is applicable for various types of displays. The backlighting module of the invention comprises a substrate 10, a plurality of a first LEDs 11, a plurality of second LEDs 12 and a light guide plate 13, wherein the light guide plate 13 covers the first LEDs 11 and the second LEDs 12 for guiding lights emitted from the first LEDs 11 and the second LEDs 12, so as to uniformly distributing the emitting light.

The first LEDs 11 and the second LEDs 12 are installed on the substrate 10, and the first LEDs 11 are arranged in a row and separated by a first interval X greater than 0 cm and smaller than or equal to 10 cm from one another. The first LEDs 11 emit light in a direction parallel to the substrate 10. The second LEDs 12 emit light in another direction opposite to the aforementioned direction and are arranged alternately relative to the first LEDs 11. The second LEDs 12 are arranged within spaces corresponding to the first intervals and are apart from one another. The first LEDs 11 and the second LEDs 12 form a light bar together. At least one light bar is formed on the substrate 10. The quantity of light bars can be increased according to the area of the light exiting surface of the backlighting module 1, so as to achieve high viewing angle and increase the applicability for larger displays.

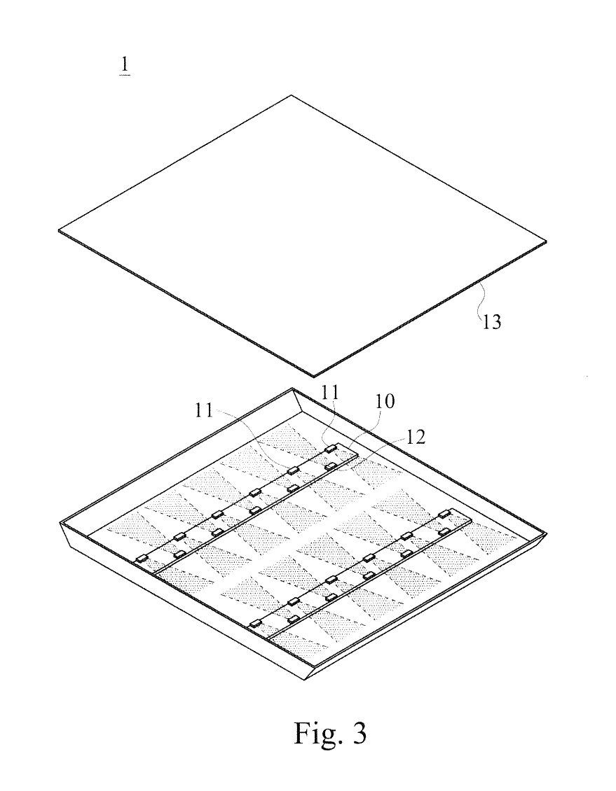

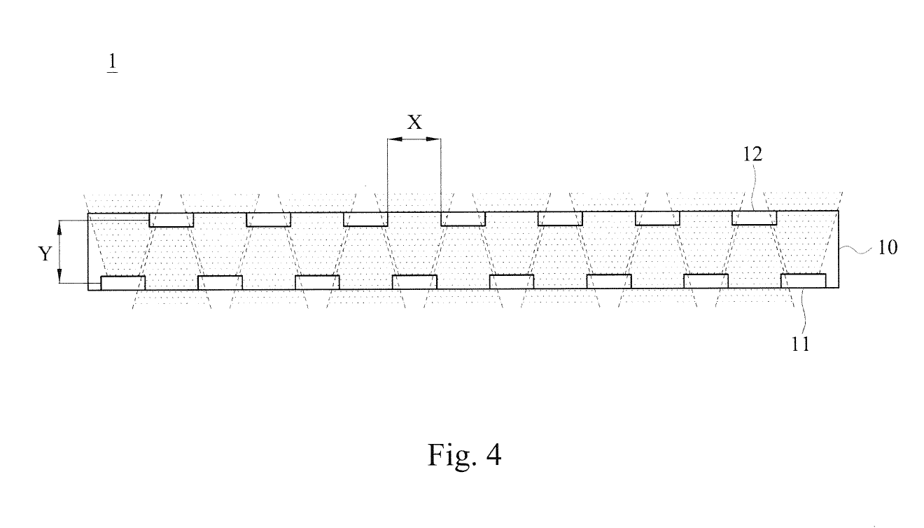

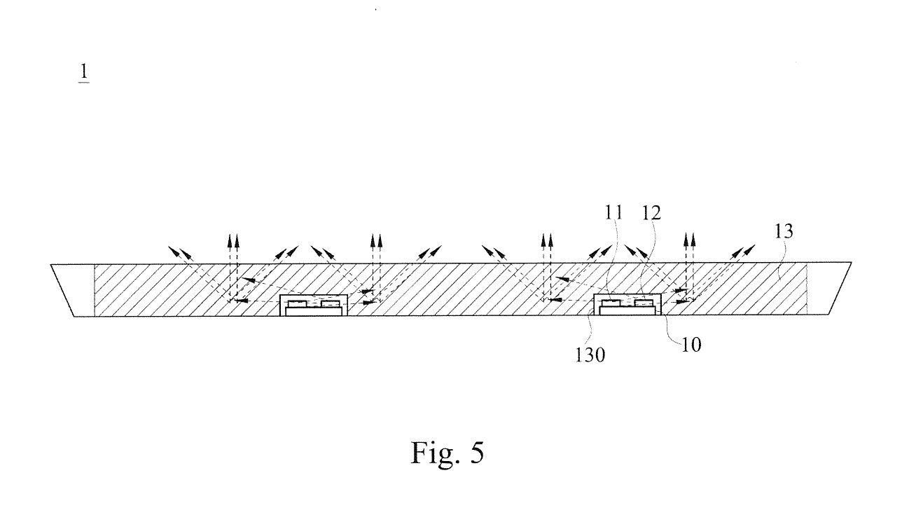

As shown in FIGS. 1 and 2, the first LEDs 11 and the second LEDs 12 can be alternately arranged relative to each other along a straight line in the light bar. Alternatively they can be arranged in a way as shown in FIGS. 3 to 5. With reference to FIGS. 3 to 5 for a perspective view, a schematic view and a sectional view of two implementation modes of the second preferred embodiment of the present invention respectively. The first LEDs 11 are arranged in a row and separated by a first interval from each other and emit light in a direction. The second LEDs 12 are arranged in another row and emit light in another direction opposite to the aforementioned direction. The row consisting the first LEDs 11 and the row consisting the second LEDs 12 are separated by the second interval Y, so that the first LEDs 11 and the second LEDs 12 are parallelly and alternately arranged on both sides of the light bar. The second interval Y falls within a range of 0<Y≦5 cm. The longitudinal locations of the second LEDs correspond to the spaces between the first LEDs 11 so that the lights emit by the second LEDs 12 can pass through the spaces in between the first LEDs 11. Any two first LEDs 11 and a second LED 12, or any two second LEDs 12 and a first LED 11 form a triangular shape. Such arrangement can improve the overall color difference distribution and improve the luminance uniformity while reducing the quantity of LED light sources used and the power consumption of the module, and complying with the requirements of environmental protection and energy saving.

Since the first LEDs 11 and the second LEDs 12 are considered as edge light emitting devices, therefore the light source can be guided to the light exiting surface of the backlighting module 1. The light guide plate 13 has a plurality of slots 130 corresponding to the light bar; wherein the slots 130 are rectangular spaces for containing the first LEDs 11 and the second LEDs 12. And the light guide plate 13 has a reflective microstructure or mesh provided for uniformly distributing lights emitted from the first LEDs 11 and the second LEDs 12 which are guided upwardly toward the light exiting surface.

What is claimed is:

1. A direct edge-lit backlighting module, comprising at least one substrate, a plurality of first LEDs, a plurality of second LEDs and a light guide plate, and the first LEDs and the second LEDs being installed on the substrate, and the light guide plate covering the first LEDs and the second LEDs, for guiding lights emitted from the first LEDs and the second LEDs to emit light with uniform distribution of light intensity characterized in that the first LEDs are separated by a first interval X from one another and emit a light in a direction parallel to the substrate, and the first interval X falls within a range of 0<X≦10 cm; the second LEDs emit a light in another direction opposite to the direction and are arranged alternately relative to the first LEDs; and the second LEDs are provided at locations corresponding to the first intervals and are apart from one another, such that at least one light bar is formed on the substrate.

2. The direct edge-lit backlighting module of claim 1, wherein the first LEDs and the second LEDs are parallelly and alternately arranged with a second interval Y apart from each other on both sides of the light bar, and the second interval Y falls within a range of 0<Y≦5 cm.

3. The direct edge-lit backlighting module of claim 1, wherein the first LEDs and the second LEDs are alternately arranged along a straight line of the light bar.

4. The direct edge-lit backlighting module of claim 1, wherein the light guide plate has a plurality of slots corresponding to the light bar, and the slots are rectangular spaces for containing the first LEDs and the second LEDs.

5. The direct edge-lit backlighting module of claim 4, wherein the light guide plate has a reflective microstructure or mesh for guiding the lights emitted from the first LEDs and the second LEDs that are parallel to the substrate upward.
